(19) United States
(12) Patent Application Publication
(10) Pub. No.: US 2017/0102025 A1
(43) Pub. Date: Apr. 13, 2017

(54) PISTON MACHINE

(71) Applicant: Lars Thomas Johansson, Yven (NO)

(72) Inventor: Lars Thomas Johansson, Yven (NO)

(21) Appl. No.: 15/267,152

(22) Filed: Sep. 16, 2016

(30) Foreign Application Priority Data
Sep. 18, 2015 (NO) 20151228

(51) Int. Cl. F16C 9/04; F01M 11/02; F16C 7/02; F16C 19/04; F16C 19/24; F01M 9/10; F16C 17/02

(52) U.S. Cl. CPC F16C 9/04; F01M 9/102; F01M 11/02; F16C 17/022; F16C 19/04; F16C 19/24; F16C 7/023; F01M 2011/026; F16C 2360/18

(57) ABSTRACT

A piston machine with a rotating shaft (106),

wherein the piston machine comprises at least two circular bearings that are radially stacked and rotatable relative each other arranged about said rotating shaft (106).

### TECHNICAL FIELD

The present invention relates to the field of split bearings and crankshafts and/or camshafts in piston machines, and especially in internal combustion engines where it is desirable with low friction.

### BACKGROUND

In today's society it is relevant to reduce the amount of energy lost due to friction in mechanical devices. In internal combustion engines, roughly 20% of the internal combustion engine's friction originates from crankshaft bearings. The present invention relates to split bearings. In prior art the crankshaft and connecting rod is supported by single split bearings. This configuration has large energy losses through friction. It is desirable with a piston machine with an extended service life and a more energy efficient solution. These split bearings have a relatively short service life due to friction and wear and tear. These bearings consume a lot of energy. These single bearings have a limited maximal rotational speed and it can be difficult to combine high rotational speed with high pressure/load. It is desirable to extend the service life of these bearings and have a more energy-effective solution. It is also desirable with bearing that can withstand higher rotational speed and that can combine high speed and high load. High friction will result in high temperatures, high temperatures can damage the lubricant, and this will affect the service life of the bearing. U.S. Pat. No. 1,494,695 (A) and U.S. Pat. No. 2,475,493 (A) utilizes a low friction roller- and ball bearing with parallel rows of rotating elements. U.S. Pat. No. 7,954,600 B2 has the aim to reduce power losses in an internal combustion engine.

Patent JP2009057992 (A) describes a multilayer foil bearing assembly that aims to provide a bearing enabling silent operation, having little torque and little wear during start and stop, and suitable for supporting a crankshaft of an engine, a main shaft of a turbo machine and the like. Patent JP2006170420 (A) describes an outer ring for half-split bearing and half-split bearing provided therewith to prevent deformation of an outer ring raceway track caused by matching of both of divided outer rings by preventing both of divided outer rings from deforming in the other in the outer part other than a matching part. Patent JPH08219161 (A) has the purpose to provide a cage for a roller bearing provided with an oil seal and a oiling dividing function, in a roller bearing in which oiling of lubrication oil is necessitated and also oiling is necessitated on the other bearing part. The U.S. Pat. No. 6,164,159 (A) patent describes a motorcycle flywheel assembly which includes a fork rod and a blade rod are positioned on a common crank pin. The US 20157078692 (A1) patent describes a bearing assembly including a connecting rod with a first end and a second end, the second end defining a first outer raceway and a second outer raceway with a thrust ring therebetween, a crankshaft defining a cylindrical inner raceway, a first plurality of radial roller elements disposed between the first outer raceway and the inner raceway, a second plurality of radial roller elements disposed between the second outer raceway and the inner raceway.

### SHORT SUMMARY OF THE INVENTION

This invention reduces friction, wear and tear through a reduced relative motion between a crankshaft and an adjacent bearing member in sliding contact with each other. The split bearings are radially stacked and rotatable relative each other, arranged about a crankshaft or a camshaft. This leads to an extended service life, a reduction in friction and enables higher rotational engine speeds.

The present invention is suitable for use in combustion engines, pumps, compressors and similar devices.

An object of the present invention is to deal with the previously mentioned disadvantages.

It is a particular object with the present invention is to provide an internal combustion engine that reduces friction.

The invention is a piston machine with a rotating shaft, such as a crankshaft, comprising
at least two split bearings that are radially stacked and rotatable relative each other arranged about said crankshaft.

### FIGURE CAPTIONS

An illustrative and non-limiting embodiment of the present invention will be described below in detail with reference to the appended drawings, in which:

FIG. 1, illustrates an exploded view of a piston machine with a rotating shaft comprising a crankshaft, piston, connecting rod, an outer cylinder and two radially stacked bearings between a connecting rod and a crankshaft.

FIG. 2, illustrates an exploded view of a piston machine with a rotating shaft comprising a crankshaft, piston, an engine block and two radially stacked split roller bearing units between the engine block and the crankshaft main journal.

FIG. 3, illustrates an exploded view of a piston machine with a rotating shaft comprising a crankshaft, a connecting rod and three radially stacked bearings between the connecting rod and the crankshaft.

FIG. 4, illustrates an exploded view of the connecting area (401) between a first and a second ring members of a split bearing.

FIG. 5, illustrates an exploded view of a piston machine with a rotating shaft comprising a camshaft, a cylinder head and two radially stacked split bearings between the cylinder head and the camshaft bearing journal.

### EMBODIMENTS OF THE INVENTION

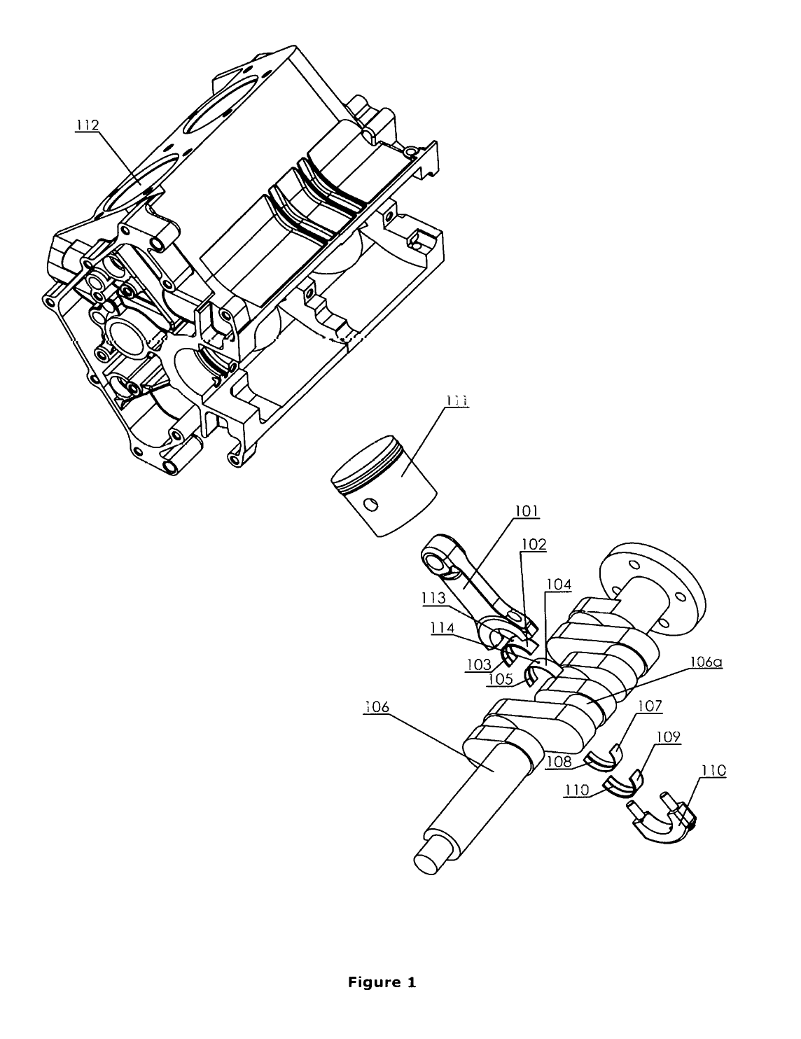

An embodiment of the invention illustrated by FIG. 1 is an exploded view of the piston machine with a rotating shaft 106 where the piston machine comprises at least two circular bearings that are radially stacked and rotatable relative each other arranged about said rotating shaft 106.

Another embodiment of the invention illustrated by FIG. 1 is an exploded view of the piston machine with a rotating shaft comprising a crankshaft 106, an outer cylinder 112, a piston 111 and two split bearings that are radially stacked and rotatable relative each other arranged about said crankshaft. In the embodiment illustrated in FIG. 1, the outer split bearing 102 and 109 is stacked between the second end of the connecting rod 101 and 110 and the inner split bearing 104 and 107. The inner split bearing 104 and 107 is stacked between the crank rod journal 106a and the outer split bearing. The inner bearing is freely moveable in the circumferential direction relative to the crankshaft rod journal 106a and the outer bearing 102 and 109. The split bearings comprise oil grooves 103, 105, 108 and 110 for distributing a lubricant, such as oil. The split bearings also comprise guide grooves 113 and 114 for transferring a lubricant. The outer bearing is kept in place by a locating lug arranged to a slot in the connecting rod. The outer split bearing 102 and 109 has, in cross section, the overall shape of an H. The inner split bearing 104 and 107 has, in cross section, the overall shape of a filled rectangle. The inner split bearing is arranged fixed in the axial and radial direction by the outer split bearing.

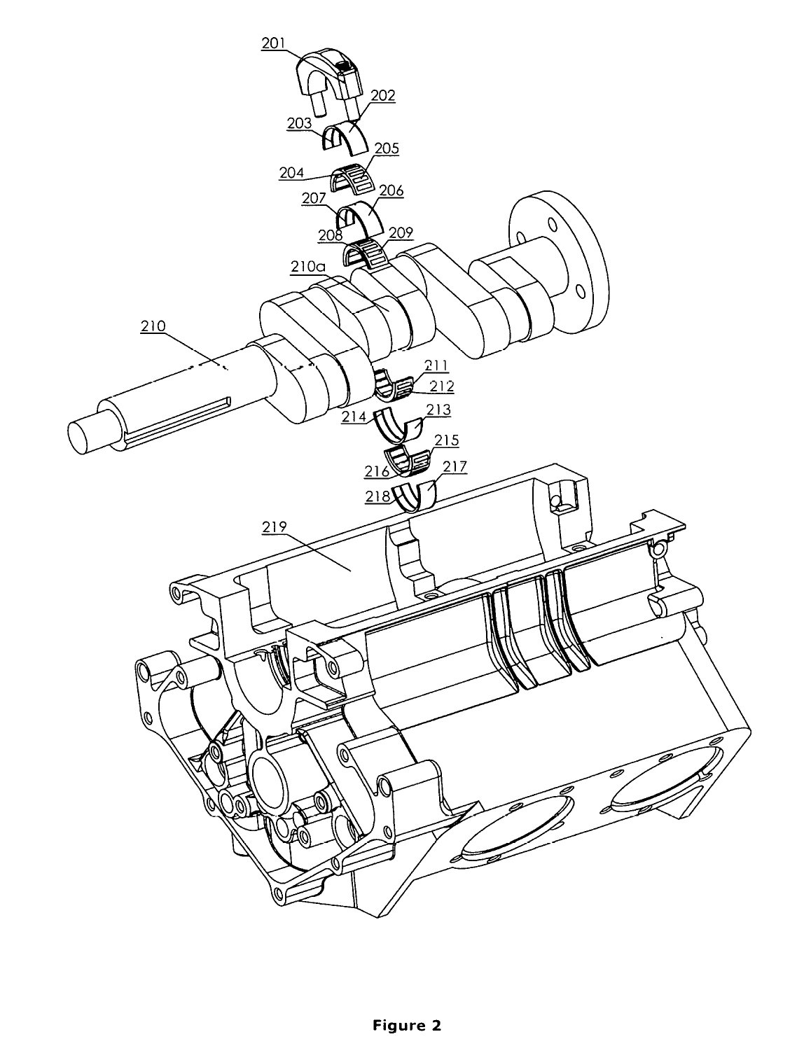

Another embodiment of the invention illustrated by FIG. 2, the stacked bearings are roller bearings. The outer split roller bearing unit 202, 205, 217, 215 in the radial direction, is stacked between the engine block 219 and the inner split roller bearing unit 206, 209, 211 and 213. The inner split bearing unit is stacked between the outer split bearing unit and the main journal on the crankshaft 210a. Each roller bearing unit comprises a split ring and 202, 206, 213, 217 rollers 205, 209, 212, 216 arranged in a roller cage 204, 208, 211 and 215. The outer bearing ring 202, 217 is kept in place by a locating lug arranged to a slot in the engine block 219. The inner split bearing unit is freely moveable in the circumferential direction relative to the crankshaft main journal and the outer spit bearing. The outer rollers and roller cage is freely movable in the circumferential direction relative to the inner roller bearing unit. Both split bearings rings 202, 206, 213, 217 have, in cross section, the overall shape of an H. The split bearings comprise oil grooves 203, 207, 214 and 218, and guide groves for distributing a lubricant, such as oil.

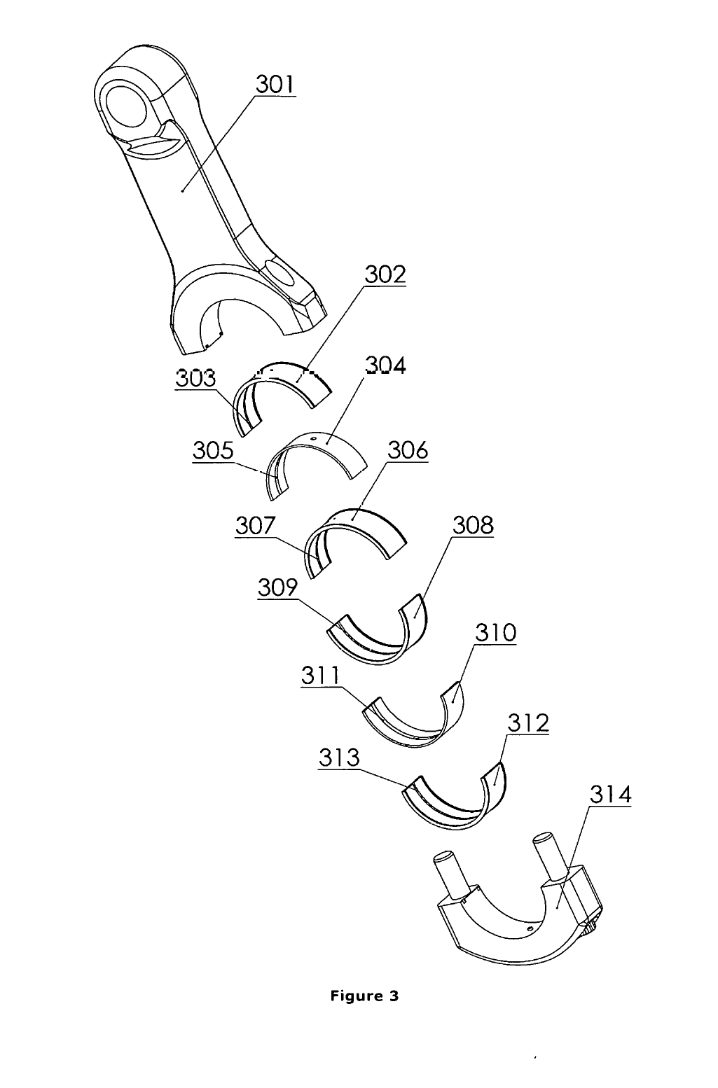

Another embodiment of the invention illustrated by FIG. 3 is an exploded view of the piston machine which comprises three split bearings that are radially stacked and rotatable relative each other arranged about a crankshaft (not shown). In the embodiment illustrated in FIG. 3, the outer split bearing 302 and 312 is stacked between the second end of the connecting rod 301 and 314 and the middle split bearing 304 and 310. The middle split bearing 304 and 310 is stacked between the outer split bearing and the inner split bearing. The inner split bearing 306 and 308 is stacked between the crank rod journal and the middle split bearing. The inner and middle split bearing are freely moveable in the circumferential direction relative to the crankshaft rod journal and the outer bearing. The split bearings comprise oil grooves 303, 305, 307, 309, 311 and 313 for distributing a lubricant, such as oil. The split bearings also comprise guide grooves for transferring the lubricant between the different split bearings. The outer bearing is kept in place by a locating lug arranged to a slot in the connecting rod. The outer split bearing has, in cross section, the overall shape of an H. The middle split bearing has, in cross section, an overall shape of an I. The inner split bearing has, in cross section, the overall shape of an U. The inner split bearing are arranged fixed in the axial and radial direction by the middle split bearing. The middle split bearing are arranged fixed in the axial and radial direction by the outer split bearing.

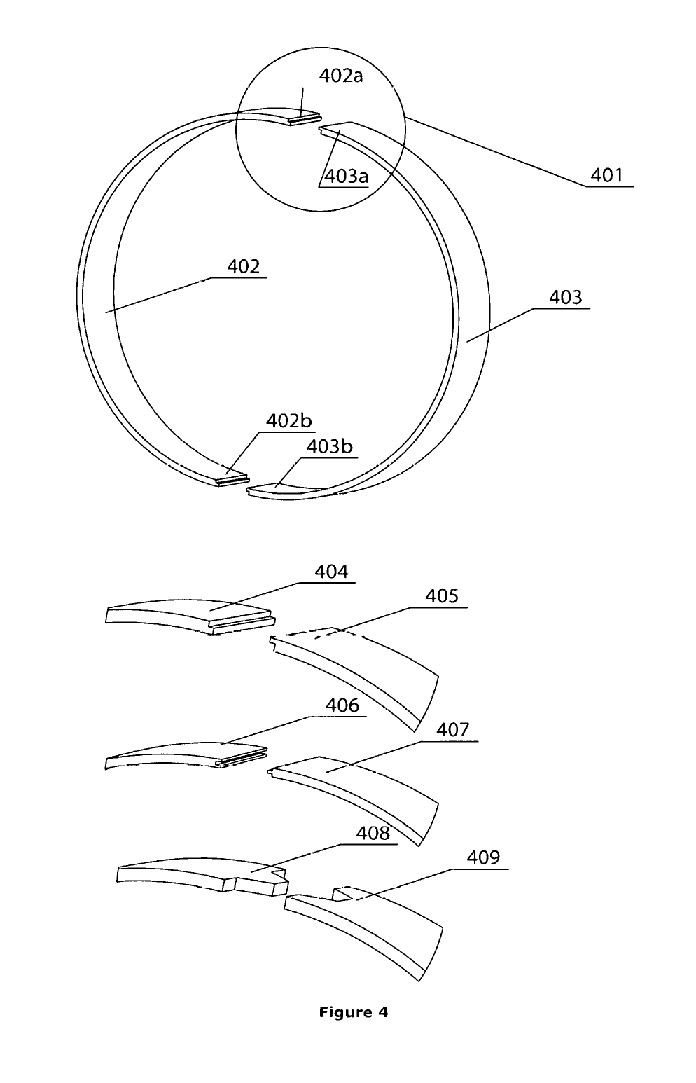

Another embodiment of the invention illustrated by FIG. 4 is an exploded view of two meshing rings 401, where at least one of the split bearings comprises first and second ring members 402, 403 with respective first and second ends 402a, 402b, 403a, 403b, wherein the first ends 402a, 403a of the first and second ring members 402, 403 have an L shaped cross section, and where the two first ends 404, 405 are inverted with respect to each other and mesh.

Another embodiment of the invention illustrated by 406 and 405 in FIG. 4, where at least one of the split bearings comprises first and second ring members 402, 403 with respective first and second ends 402a, 402b, 403a, and 403b, wherein the first ends 402a, 403a of the first and second ring members 402, 403 have an L shaped cross section, and where the two first ends 404, 405 are inverted with respect to each other and mesh.

Another embodiment of the invention illustrated by 406 and 407 in FIG. 4, where at least one of the split bearings comprises first and second ring members 402, 403 with respective first and second ends 402a, 402b, 403a, and 403b, wherein the first ends 406, 407 of the first and second ring members 402, 403 has a feather shaped axial cross section and a tongue shaped axial cross section, respectively, and mesh.

In embodiment illustrated by 408 and 409 in FIG. 4, two rings have a feather and tongue shaped meshing face.

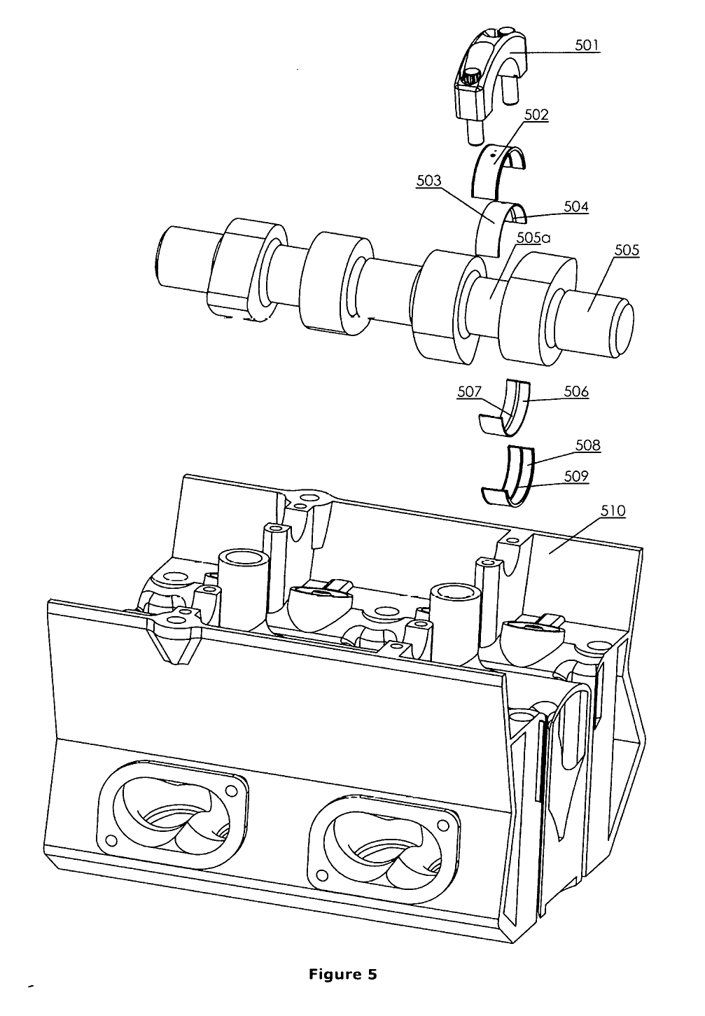

Another embodiment of the invention illustrated by FIG. 5 is an exploded cross section view of the piston machine comprising a camshaft 505, a cylinder head 510 and two split bearings 502, 503, 506, 508 that are radially stacked and rotatable relative each other arranged about the camshaft. In the embodiment illustrated in FIG. 5, the outer split bearing 502 and 508 is stacked between the cylinder head 510 and the inner split bearing 506 and 503. The inner split bearing 506 and 503 is stacked between the camshaft bearing journal 505a and the outer split bearing. The inner bearing is freely moveable in the circumferential direction relative to the camshaft bearing journal 505a and the outer bearing 502 and 508. The split bearings comprise oil grooves 504, 507 and 509 for distributing a lubricant, such as oil. The split bearings also comprise guide grooves for transferring the lubricant. The outer bearing is kept in place by a locating lug arranged to a slot in the cylinder head. The outer split bearing 502 and 508 has, in cross section, the overall shape of an H. The inner split bearing 503 and 508 has, in cross section, the overall shape of a filled rectangle. The inner split bearing is arranged fixed in the axial and radial direction by the outer split bearing.

It should be noted that the embodiments illustrated and described were given merely by way of non-limiting indicative examples and that modifications and variations are possible within the scope of the invention as defined by the appended claims. Thus, the invention applies not only to rollers but also other rotational elements, such as balls. It is easily understood that several rows of rotating elements axially separated can be used. A combination of row with different rotating element is possible. It should also be easily understood that each plain bearing ring can be a combination of arc segment or half segment. Two ring members can also have different meshing shapes at the first and second ends. It should also easily be understood that the bearings can be used between the camshaft and the engine block.

This invention reduces friction and wear and tear by the use of at least two split bearings that are radially stacked and rotatable relative each other arranged about a crankshaft. This leads to an extended service life, a reduction in friction and enables a higher maximal speed. The definition parallel units means, that the unit has at least two bearings that are radially stacked and rotatable relative each other, arranged about a crankshaft.

Radially Stacked Crankshaft/Camshaft Bearings:

The kinetic friction (Eq. 1) for crankshaft bearings can be estimated by Fₖ:

$$\frac{1}{{F}_{k}} = \frac{1}{{μ}_{k 1} {G}_{n 1}} + \frac{1}{{μ}_{k 2} {G}_{n 2}} + … \frac{1}{{μ}_{kn} {G}_{nn}} \qquad ( Equation 1 )$$

Were μ is the constant coefficient for the bearing, G is a variable depending bearing type, load, and the bearing diameter. As follows from Equation 1, the kinetic friction is inversely proportional to the sum of the individual kinetic frictional components in a device with parallel connected bearings. Lowest kinetic friction occurs when; μₖ₁Gₙ₁=μₖ₂Gₙ₂ . . . =μₖₙGₙₙ.

Friction yields heat and wear and with the use of this invention, the properties for the seals can be adjusted to match the application. The properties such as relative motion between individual bearings can be tuned to match the application. This invention has a redundant function. The redundant function is that one or more of the bearing rings can fail and the device will still function, but with higher friction and with more wear.

What is claimed is:

1. A piston machine including:
a crankshaft having a crankshaft rod journal;
a connecting rod connected to a piston in a first end and to the crankshaft rod journal in a second end; and
at least two circular bearings that are radially stacked and rotatable relative each other;
wherein the two bearings are arranged between the second end and the crankshaft rod journal,
wherein the two bearings are roller bearings or plain bearings.

2. The piston machine according to claim 1 comprising;
an engine block, wherein said crankshaft comprises a crankshaft main journal, wherein the two bearings are arranged between the engine block and the crankshaft main journal.

3. The piston machine according to claim 1 comprising;
a camshaft, and
an engine cylinder head, wherein said camshaft comprises a camshaft bearing journal, wherein the two bearings are arranged between the engine cylinder head and the camshaft bearing journal.

4. The piston machine according to any of the preceding claims, wherein said two bearings are split bearings.

5. The piston machine according to any of the preceding claims, wherein at least one of said two bearings comprises an internal or external oil groove.

6. The piston machine according to any of the preceding claims, wherein at least one of said two bearings comprises at least a guide groove arranged to transfer oil.

7. The piston machine according to claims 1 and 4, wherein at least one of said plain split bearings has, in a cross section, the shape of an H.

8. The piston machine according to claims 1 and 4, wherein at least one of said plain split bearings has, in a cross section, the shape of a filled rectangle.

9. The piston machine according to claims 1 and 4, wherein at least one of said plain split bearings has, in a cross section, the shape of an U.

10. The piston machine according to claims 1 and 4, wherein at least one of said split bearings comprises first and second ring members with respective first and second ends, wherein the first ends of the first and second ring members have an L shaped cross section, and where the two first ends are inverted with respect to each other and mesh.

11. The piston machine according to claims 1 and 4, wherein at least one of said split bearings comprises first and second ring members with respective first and second ends, wherein the first ends of the first and second ring members has a feather shaped axial cross section and a tongue shaped axial cross section, respectively, and mesh.
